(19) United States
(12) Patent Application Publication
(10) Pub. No.: US 2026/0303631 A1
(43) Pub. Date: Oct. 1, 2026

(54) Network Intrusion Detection and Response System

(71) Applicant: Oracle International Corporation, Redwood Shores, CA (US)

(72) Inventors: Badr Mohamed Tharwat Mohamed, Riyadh (SA); José Emanuel Gomes das Neves Palmeiro, Madrid (ES)

(73) Assignee: Oracle International Corporation, Redwood Shores, CA (US)

(21) Appl. No.: 19/269,810

(22) Filed: Jul. 15, 2025

Related U.S. Application Data
(60) Provisional application No. 63/779,095, filed on Mar. 27, 2025.

(51) Int. Cl. H04L 9/40

(52) U.S. Cl. CPC H04L 63/1425; H04L 63/20

(57) ABSTRACT

Techniques for detecting and responding to network intrusions are disclosed. A network security system, executing in a computer network, accesses network details, including a network scope, a network definition, and/or an existing security policy associated with the computer network. The system further accesses network flow logs, including metadata that describes network traffic associated with the computer network. The system prompts a machine learning model to (a) identify anomalous network activity based at least in part on the network details and the network flow logs and (b) generate new network security policies when anomalous network activity is detected. The system receives, from the machine learning model, a new network security policy that addresses anomalous activity detected by the machine learning model. The system deploys the new security policy to the computer network without human review or approval of the new security policy.

Each of the following applications are hereby incorporated by reference: Application No. 63/779,095 filed on Mar. 27, 2025. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to network security. In particular, the present disclosure relates to detecting and mitigating anomalous network activity.

### BACKGROUND

Modern network architectures are highly dynamic and complex, making the networks susceptible to sophisticated threats, like lateral movement, insider attacks, and zero-day exploits. A network intrusion can have various detrimental effects on the functioning of both the network and computer systems within the network. An intruder may consume bandwidth, overload system resources, and/or execute a malicious process that slows down network and computer performance. Malicious activities, such as flooding the network with traffic and/or corrupting system files, can cause system crashes and/or impede the functioning of various services, like email, databases, cloud applications, etc. An intruder may steal sensitive information, such as credentials, financial records, personal data, etc. An intruder may introduce a virus, ransomware, and/or spyware that disrupts operations, encrypts data, and/or spies on user activity. An intruder may take control of a computer system, install a backdoor, and/or use a compromised computer for a subsequent attack. An intruder may modify or delete crucial data, causing data loss or corruption. In addition, a breach may degrade security, leaving the network more exposed to future attacks.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A illustrates a system in accordance with one or more embodiments;

FIG. 1B illustrates a machine learning engine in accordance with one or more embodiments;

FIG. 2 illustrates an example set of operations of the machine learning engine of FIG. 1B;

FIG. 3 illustrates an example set of operations for detecting anomalous network activity and remediating the anomalous activity in accordance with one or more embodiments;

FIG. 4A illustrates an example policy prompt in accordance with one or more embodiments;

FIG. 4B illustrates an example network flow log in accordance with one or more embodiments;

FIG. 4C illustrates an example security policy in accordance with one or more embodiments;

FIG. 5 illustrates an example of detecting and mitigating anomalous activity in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. ZERO TRUST SENTRY SYSTEM ARCHITECTURE
3. MACHINE LEARNING ENGINE ARCHITECTURE
4. MACHINE LEARNING ENGINE OPERATION
5. GENERATIVE MODELS
6. DETECTING ANOMALOUS NETWORK ACTIVITY AND GENERATING POLICIES FOR MITIGATING THE ANOMALOUS ACTIVITY
7. EXAMPLE PROMPTS AND FLOW LOGS FOR DETECTING ANOMALOUS NETWORK ACTIVITY AND NEW SECURITY POLICY FOR MITIGATING THE ANOMALOUS NETWORK ACTIVITY
8. EXAMPLE OF DETECTING AND MITIGATING ANOMALOUS ACTIVITY
9. PRACTICAL APPLICATIONS, ADVANTAGES & IMPROVEMENTS
10. COMPUTER NETWORKS AND CLOUD NETWORKS
11. HARDWARE OVERVIEW
12. MISCELLANEOUS; EXTENSIONS

### 1. General Overview

One or more embodiments use machine learning techniques to detect anomalous activity and generate policies for remediating the anomalous activity. The system accesses network details, such as a network scope, a network definition, an existing security policies associated with a computer network, and/or network flow logs associated with the network. The system prompts a machine learning model to (a) identify anomalous network activity based on the network details and flow logs and (b) generate a new network security policy responsive to detecting anomalous activity.

One or more embodiments use a zero trust packet routing (ZPR) framework to direct packets received by the network through a verification layer. The verification layer assesses the packets and determines if there are any security policies in place that prohibit the packet from proceeding through the computer network.

One or more embodiments apply a new security policy to the network without requiring a human to review or approve the policy, allowing for rapid deployment of new policies. Deploying a security policy without requiring human review or approval reduces delays in securing the network, reducing the amount of time the network is vulnerable to security threats such as those described above. Thus, one or more embodiments improve the functioning of the network and computer systems within the network, compared with approaches that depend on human review and approval.

One or more embodiments described in this Specification and/or recited in the claims may not be included in this General Overview section.

### 2. Zero Trust Sentry System Architecture

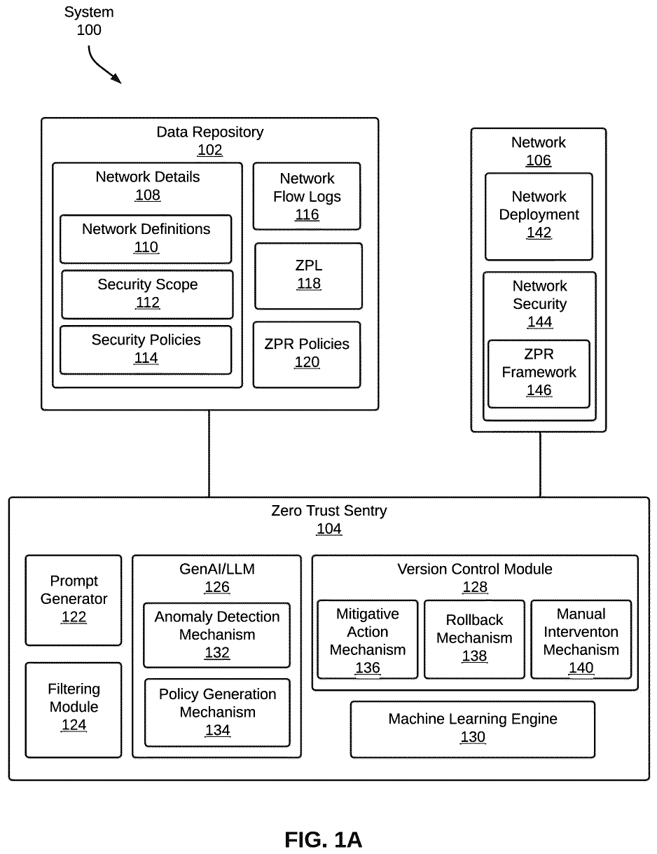

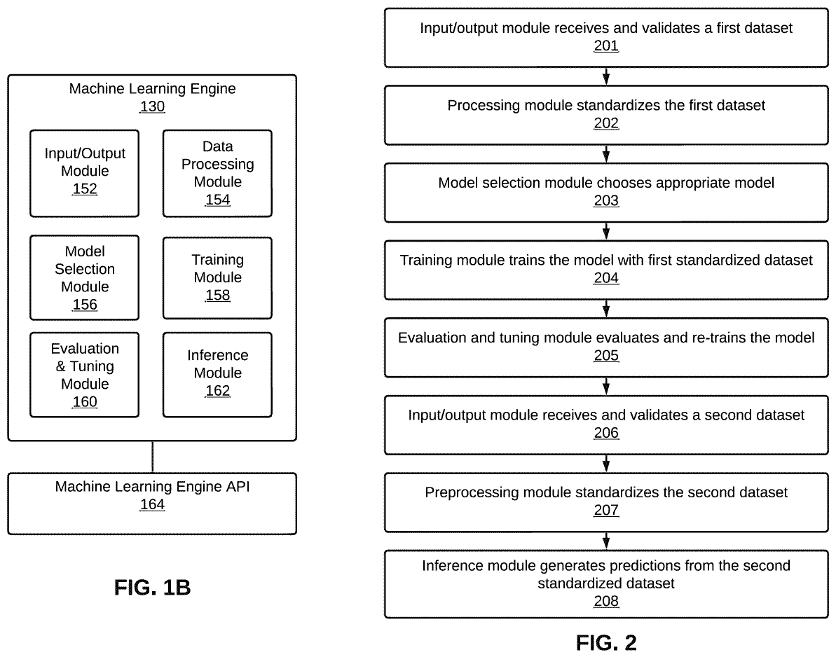

FIG. 1 illustrates a system 100 in accordance with one or more embodiments. As illustrated in FIG. 1, system 100 includes data repository 102, zero trust sentry 104, and network 106. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In one or more embodiments, data repository 102 is any type of storage unit and/or device (e.g., a file system, database, collection of tables, or any other storage mechanism) for storing data. Furthermore, data repository 102 may include multiple different storage units and/or devices. The multiple different storage units and/or devices may or may not be of the same type or located at the same physical site. Furthermore, data repository 102 may be implemented or executed on the same computing system as zero trust sentry 104. Additionally, or alternatively, data repository 102 may be implemented or executed on a computing system separate from zero trust sentry 104. Data repository 102 may be communicatively coupled with zero trust sentry 104 via a direct connection or via a network.

Information describing detecting anomalous activity and generating policy for mitigating the anomalous activity may be implemented across any components within the system 100. However, this information is illustrated within the data repository 102 for purposes of clarity and explanation.

In one or more embodiments, data repository 102 includes network details 108. Network details 108 may include network definitions 110, security scope 112, and security policies 114.

In one or more embodiments, network definition 110 refer to detailed descriptions or configurations of architecture of computer networks. Network definitions 110 may include the specification of network components, how the network components are interconnected, and protocols used by the components to communicate. Network definitions 110 may outline structure and functional aspects necessary for the network to operate and fulfill the intended purposes of the computer network.

In one or more embodiments, network definitions 110 include topology, devices and nodes, protocols, media, services, security measure, and performance specifications. Topology refers to physical and logical layout of the network. Physical topology refers to the actual arrangement of cables, computers, and other peripherals, while logical topology describes how data flows within the network. Devices and nodes include the hardware that makes up the network, e.g., routers, switches, servers, workstations, and other endpoints. Protocols are the rules and standards that govern data transmission between network devices. Common protocols include Transmission Control Protocol/Internet Protocol (TCP/IP) for routing and managing data traffic on the Internet, HyperText Transfer Protocol (HTTP) for web communications, and simple mail transfer protocol (SMTP) for email transmission. Media includes communication media types used to link network devices, e.g., Ethernet cables-wired, fiber optics, or radio waves-wireless, e.g., WiFi and Bluetooth. Services include details of the services provided by the network, e.g., file sharing, internet access, printer access, and database management. Security measures include specifications for how the network is protected from unauthorized access and threats. Security measures may include firewalls, encryption methods, and security protocols. Performance specifications are details about network performance parameters, including bandwidth, latency, throughput, and error rates.

In one or more embodiments, security scope 112 refers to aspects of a network dedicated to protecting data, resources, and communications from unauthorized access, use, disclosure, disruption, modification, or destruction. Security scope 112 may include threat protection, data security, compliance requirements and regulations as well as security technologies and policies. Threat protection includes the extent that security measures are in place to protect against various threats, e.g., malware, hackers, and insider threats. Data security involves strategies used to protect the integrity, confidentiality, and availability of data. Compliance and regulations detail the compliance requirements that a network is required to meet based on industry standards or government regulations, e.g., GDPR, HIPAA, or PCI-DSS. Security technologies include firewalls, encryption, intrusion detection systems, and security protocols that are implemented to safeguard the network.

In one or more embodiments, security policies 114 refer to guidelines and procedures designed to protect data, network infrastructure, and connected devices from various threats and unauthorized access. Security policies 114 define a framework for how an organization secures the network and resources. Security policies 114 may include rules that define mitigative actions for resolving different types of detected anomalies.

In one or more embodiments, security policies 114 include access control policies, network security policies, data protection policies, and incident response policies. Access control policies define who can access the network and what resources are accessible. Access control policies establish how users are authenticated and what authorization levels they have. Network security policies outline how the network is protected against unauthorized access, data breaches, and other security threats. Network security policies include use of firewalls, intrusion detection systems, and secure network protocols. Data protection policies ensure that sensitive data is adequately protected both in transit and at rest. Data protection policies address confidentiality, integrity, and availability of data. Incident response policies specify procedures for managing security breaches and other network disruptions to minimize damage and recover from incidents efficiently.

In one or more embodiments, security policies 114 include remote access policies, acceptable use policies, email security policies, change management policies, and/or disaster recovery and business continuity policies. Remote access policies govern how employees and other users connect to the network remotely, ensuring that such connections do not become vulnerabilities for security breaches. Acceptable use policies define what behaviors are acceptable on the network to prevent risky behaviors that could expose the network to security threats. Email security policies address security measures specifically related to email. Change management policies ensure that all changes to the network infrastructure are performed in a controlled manner to prevent unintended disruptions or vulnerabilities. Disaster recovery and business continuity policies outline how an organization will continue to operate in the event of a major network failure or disaster.

In one or more embodiments, data repository 102 includes network flow logs 116. Network flow logs 116 refer to logs that capture information about IP traffic going to and from network interfaces in virtual private clouds (VPCs), subnets, or specific network interfaces. Network flow logs 116 record metadata of data packets, including source and destination IP addresses, port numbers, protocols used, a number of packets, a number of bytes, and status, i.e., action taken on the traffic, e.g., accepted or rejected. The system may store network flow log data in a centralized log management solution, e.g., a native cloud provider service or third-party tools, that can aggregate, analyze, and visualize log data. Network flow logs 116 may include logs for network traffic originating from high risk machines, e.g., critical system subnets.

In one or more embodiments, data repository 102 includes Zero Trust Packet Routing language (ZPL) 118. ZPL 118 is a language used to define security policies within a ZPR framework. ZPL 118 is a language designed for readability and clarity. ZPR language 118 focuses on “allow” statements that promote a positive security model. ZPR language 118 leverages attributes to define policies rather than relying solely on individual identities. Attributes relied by ZPR language 118 refer characteristics of users, devices, or data, e.g., roles, group memberships, and security classifications.

In one or more embodiments, data repository 102 includes ZPR policies 120. ZPR policies 120 are security policies or rules that govern network traffic with a ZPR framework. ZPR policies 120 define rules that govern network traffic based on attributes of communicating entities. ZPR policies 120 are defined using ZPL 118.

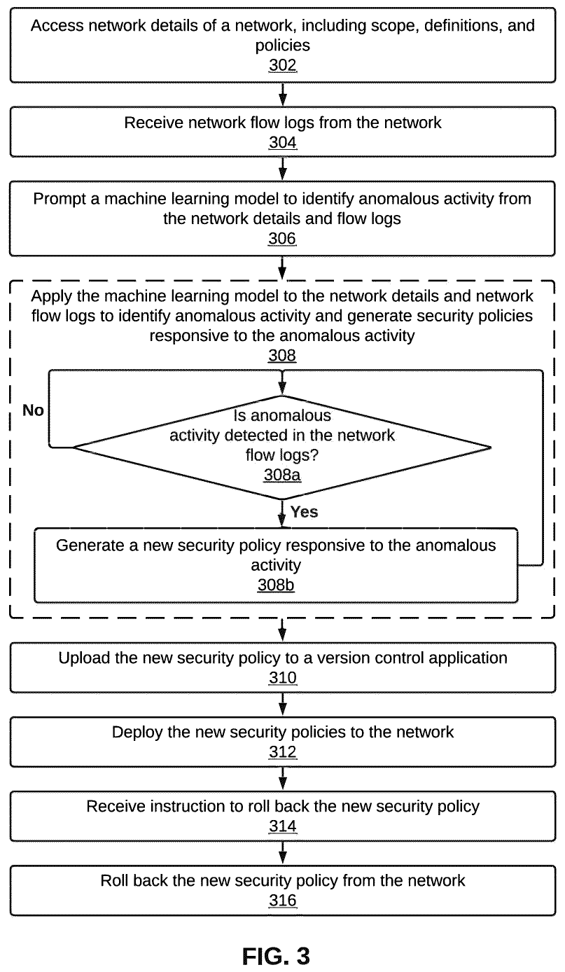

In one or more embodiments, zero trust sentry 104 refers to hardware and/or software configured to perform operations described herein for detecting anomalous activity in a network and generating network security policies responsive to the anomalous. Zero trust sentry 104 may also refer to hardware and/or software configured to perform operation described herein for implementing the network security policies that are responsive to the anomalous activity. Examples of operations for detecting and mitigating anomalous network activity are described below with reference to FIG. 3.

In one or more embodiments, zero trust sentry 104 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, zero trust sentry 104 includes a prompt generator 122. Prompt generator 122 refers to hardware and/or software configured to perform operations described herein for accessing network details and network flow logs and providing the network details and network flow logs to Generative Artificial Intelligence (GenAI)/Large Language Model (LLM) 126.

In one or more embodiments, zero trust sentry 104 includes a filter module 124. Filter module 124 refers to hardware and/or software configured to perform operations described herein for filtering network flow logs. Filter module 124 may filter network flow logs based on a higher susceptibility to attacks.

In one or more embodiments, zero trust sentry 104 includes GenAI/LLM 126. GenAI/LLM 126 refers to hardware and/or software configured to perform operations described herein for detecting anomalous activity from network flow logs and for generating network security policies for mitigating the anomalous activity. As will be described in further detail below, GenAI models are a class of algorithms designed to generate new data that resemble the training data. LLMs are a subset of machine learning models specifically designed to process, understand, and generate human language. LLMs may include Generative Pre-Trained Transformer (GPT) and Bidirectional Encoder Representations from Transformers (BERT).

In one or more embodiments, GenAI/LLM 126 is fine-tuned to improve anomaly detection and mitigation actions. Training data for fine-tuning GenAI/LLM 126 may include Zero Trust Packet Routing Language (ZPL). Training data may also include attack examples.

In one or more embodiments, GenAI/LLM 126 includes anomaly detection mechanism 132 and policy generation mechanism 134. Anomaly detection mechanism 132 refers to hardware and/or software configured to perform operations described herein for detecting anomalous activity from network flow logs. Policy generation mechanism 134 refers to hardware and/or software configured to perform operations described herein for generating network security policies for mitigating the detected anomalous activity. The same or different models may perform the anomaly detection and the network security policy generation. A detailed description of the structure and function of example GenAI, LLM, and other machine learning models will provide with reference to FIGS. 1B and 2.

In one or more embodiments, zero trust sentry 104 includes version control module 128. Version control module 128 refers to hardware and/or software that performs the operations described herein for managing source code over time. Version control module 128 tracks modifications to source code and allows for reversion to the source code.

In one or more embodiments, version control module 128 includes mitigative action mechanism 136. Mitigative action mechanism 136 refers to hardware and/or software that performs the operations described herein for implementing new network security policies generated by GenAI/LLM 126. Mitigative action mechanism 136 may isolate affected services, disabling suspicious connections.

In one or more embodiments, version control module 128 includes rollback mechanism 138. Rollback mechanism 138 refers to hardware and/or software that performs the operations described herein for reverting to earlier versions of source code. Rollback mechanism 138 may be configured to automatically roll back or reverse mitigative actions based on further AI validation or human intervention.

In one or more embodiments, version control module 128 includes manual intervention mechanism 140. Manual intervention mechanism 140 refers to hardware and/or software that performs operations described herein for manual intervention of a user in mitigating for anomalous activity. Manual intervention mechanism 140 provides an interface for a user to override an action taken by the system. Manual intervention mechanism 140 may permit actions, such as re-enabling access or approving critical decisions, e.g., restarting services.

In one or more embodiments, version control module 128 includes Git. Git is an open-source distributed version control system. GitOps is an operational framework that uses Git as the single source of truth for infrastructure and application configurations. With GitOps, the system components, e.g., infrastructure, applications, and configurations, is described declaratively. Declarative descriptions express a desired state of the system in a format that specifies ‘what’ the system should look like, not ‘how’ to achieve that state. Declarative descriptions may include application code and infrastructure. Changes to the system are committed in Git. Git provides a comprehensive audit trail and an ability to revert to a previous state. GitOps includes automated deployment tools that make an actual state of a system match a desired state described in Git. Software agents continuously monitor an actual state of a system and correct any drift from a desired state. Automatic reconciliation ensures that configurations in Git are always reflected in the live system. A Git repository (repo) stores an entire history of changes to a project's files and directories. The Git repo tracks changes and enables reversion of files to a previous state. Git repos may include a local repository and a remote repository. A remote repository is a repository hosted on servers or platforms, e.g., GitHub, GitLab. Changes are pushed to a remote repository prior to deployment.

In one or more embodiments, zero trust sentry 104 includes machine learning engine 130. Machine learning engine 130 refers to hardware and/or software configured to perform the operations described herein for training and applying machine learning models. The structure and function of machine learning engine 130 will be described below in detail with reference to FIGS. 1B and 2.

In one or more embodiments, network 106 refers to the infrastructure and services that enable communication and data transfer between resources. Network 106 may include on-premise, cloud, or hybrid networks. On-premise networks involve hosting and maintaining internet technology (IT) infrastructure, including servers, storage, and networking hardware, within an organization's physical location. Cloud networks utilize computing resources and services provided by third-party cloud providers, e.g., Oracle. Hybrid networks combine on-premise infrastructure with cloud resources.

In one or more embodiments, network deployment 142 refers to allocation, configuration, and management of all assets that contribute to the functionality and performance of network 106. Network deployment 142 may include physical hardware, virtual components, software solutions, and connectivity infrastructure.

In one or more embodiments, network security 144 encompasses the policies, procedures, and technologies used to protect the integrity, confidentiality, and accessibility of network 106 and the data transmitted through network 106.

In one or more embodiments, network security 144 includes ZPR framework 146. ZPR framework 146 is a framework that operates on the principle of “never trust, always verify.” No device or user is inherently trusted regardless of the location within the network 106. ZPR framework 146 focuses on identity and attributes of users and devices rather than relying solely on network locations, e.g., IP addresses. Access decisions in the ZPR framework are based on attributes, e.g., user roles, device types, and data sensitivity. Security policies are enforced continuously at a packet level. ZPR framework 146 includes an identity-aware network security layer. ZPR framework 146 enables enforcement of consistent security policies across diverse environments. ZPR framework 146 authenticates and authorizes network packets based on predefined policies.

### 3. Machine Learning Engine Architecture

FIG. 1 illustrates a machine learning engine 130 in accordance with one or more embodiments. As illustrated in FIG. 1, machine learning engine 130 includes input/output module 152, data preprocessing module 154, model selection module 156, training module 158, evaluation and tuning module 160, and inference module 162.

In accordance with an embodiment, input/output module 152 serves as the primary interface for data entering and exiting the system, managing the flow and integrity of data. This module may accommodate a wide range of data sources and formats to facilitate integration and communication within the machine learning architecture.

In an embodiment, an input handler within input/output module 152 includes a data ingestion framework capable of interfacing with various data sources, such as databases, application programming interface (APIs), file systems, and real-time data streams. This framework is equipped with functionalities to handle different data formats (e.g., CSV, JSON, XML) and efficiently manage large volumes of data. It includes mechanisms for batch and real-time data processing that enable the input/output module 152 to be versatile in different operational contexts, whether processing historical datasets or streaming data.

In accordance with an embodiment, input/output module 152 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 152 includes an output framework designed to handle the distribution and exportation of outputs, predictions, or insights. Using the output framework, input/output module 152 formats these outputs into user-friendly and accessible formats, such as reports, visualizations, or data files compatible with other systems. Input/output module 152 also ensures secure and efficient transmission of these outputs to end-users or other systems in an embodiment and may employ encryption and secure data transfer protocols to maintain data confidentiality.

In accordance with an embodiment, data preprocessing module 154 transforms data into a format suitable for use by other modules in machine learning engine 130. For example, data preprocessing module 154 may transform raw data into a normalized or standardized format suitable for training ML models and for processing new data inputs for inference. In an embodiment, data preprocessing module 154 acts as a bridge between the raw data sources and the analytical capabilities of machine learning engine 130.

In an embodiment, data preprocessing module 154 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 154 may be configured to handle anomalies in different ways depending on context. Data preprocessing module 154 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 154 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 154 processes new data for inference, data preprocessing module 154 replicates the same preprocessing steps to ensure consistency with the training data format. This helps to avoid discrepancies between the training data format and the inference data format, thereby reducing the likelihood of inaccurate or invalid model predictions.

In an embodiment, model selection module 156 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 156 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 156 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 156 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 156 also considers computational efficiency and resource constraints. This is meant to help ensure the selected model is both accurate and practical in terms of computational and time requirements. In an embodiment, certain features of model selection module 156 are configurable such as a configured bias toward (or against) computational efficiency.

In accordance with an embodiment, training module 158 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 158 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 158 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 158 includes logic to handle different types of data and learning tasks. For instance, it includes different training routines for supervised learning (where the training data comes with labels) and unsupervised learning (without labeled data). In the case of deep learning models, training module 158 also manages the complexities of training neural networks that include initializing network weights, choosing activation functions, and setting up neural network layers.

In an embodiment, evaluation and tuning module 160 incorporates dynamic feedback mechanisms and facilitates continuous model evolution to help ensure the system's relevance and accuracy as the data landscape changes. Evaluation and tuning module 160 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 160 performs continuous model tuning by using hyperparameter optimization. Evaluation and tuning module 160 performs an exploration of the hyperparameter space using algorithms, such as grid search, random search, or more sophisticated methods like Bayesian optimization. Evaluation and tuning module 160 uses these algorithms to iteratively adjust and refine the model's hyperparameters-settings that govern the model's learning process but are not directly learned from the data-to enhance the model's performance. This tuning process helps to balance the model's complexity with its ability to generalize and attempts to avoid the pitfalls of underfitting or overfitting.

In an embodiment, evaluation and tuning module 160 integrates data feedback and updates the model. Evaluation and tuning module 160 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 160 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 160 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 162 transforms data raw data into actionable, precise, and contextually relevant predictions. In addition to processing and applying a trained model to new data, inference module 162 may also include post-processing logic that refines the raw outputs of the model into meaningful insights.

In an embodiment, inference module 162 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 162 transforms the outputs of a trained model into definitive classifications. Inference module 162 employs the underlying model as a tool to generate probabilistic outputs for each potential class. It then engages in an interpretative process to convert these probabilities into concrete class labels.

In an embodiment, when inference module 162 receives the probabilistic outputs from the model, it analyzes these probabilities to determine how they are distributed across some or every potential class. If the highest probability is not significantly greater than the others, inference module 162 may determine that there is ambiguity or interpret this as a lack of confidence displayed by the model.

In an embodiment, inference module 162 uses thresholding techniques for applications where making a definitive decision based on the highest probability might not suffice due to the critical nature of the decision. In such cases, inference module 162 assesses if the highest probability surpasses a certain confidence threshold that is predetermined based on the specific requirements of the application. If the probabilities do not meet this threshold, inference module 162 may flag the result as uncertain or defer the decision to a human expert. Inference module 162 dynamically adjusts the decision thresholds based on the sensitivity and specificity requirements of the application, subject to calibration for balancing the trade-offs between false positives and false negatives.

In accordance with an embodiment, inference module 162 contextualizes the probability distribution against the backdrop of the specific application. This involves a comparative analysis, especially in instances where multiple classes have similar probability scores, to deduce the most plausible classification. In an embodiment, inference module 162 may incorporate additional decision-making rules or contextual information to guide this analysis, ensuring that the classification aligns with the practical and contextual nuances of the application.

In regression models, where the outputs are continuous values, inference module 162 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 162 incorporates domain-specific adjustments into its post-processing routine. This involves tailoring the model's output to align with specific industry knowledge or contextual information. For example, in financial forecasting, inference module 162 may adjust predictions based on current market trends, economic indicators, or recent significant events, ensuring that the outputs are both statistically accurate and practically relevant.

In an embodiment, inference module 162 includes logic to handle uncertainty and ambiguity in the model's predictions. In cases where inference module 162 outputs a measure of uncertainty, such as in Bayesian inference models, inference module 162 interprets these uncertainty measures by converting probabilistic distributions or confidence intervals into a format that can be easily understood and acted upon. This provides users with both a prediction and an insight into the confidence level of that prediction. In an embodiment, inference module 162 includes mechanisms for involving human oversight or integrating the instance into a feedback loop for subsequent analysis and model refinement.

In an embodiment, inference module 162 formats the final predictions for end-user consumption. Predictions are converted into visualizations, user-friendly reports, or interactive interfaces. In some systems, like recommendation engines, inference module 162 also integrates feedback mechanisms, where user responses to the predictions are used to continually refine and improve the model, creating a dynamic, self-improving system.

### 4. Machine Learning Engine Operation

FIG. 2 illustrates the operation of a machine learning engine in one or more embodiments. In an embodiment, input/output module 152 receives a dataset intended for training (Operation 201). This data can originate from diverse sources, like databases or real-time data streams, and in varied formats, such as CSV, JSON, or XML. Input/output module 152 assesses and validates the data, ensuring its integrity by checking for consistency, data ranges, and types.

In an embodiment, training data is passed to data preprocessing module 154. Here, the data undergoes a series of transformations to standardize and clean it, making it suitable for training ML models (Operation 202). This involves normalizing numerical data, encoding categorical variables, and handling missing values through techniques like imputation.

In an embodiment, prepared data from the data preprocessing module 154 is then fed into model selection module 156 (Operation 203). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 158 trains the selected model with the prepared dataset (Operation 204). It implements learning algorithms to adjust the model's internal parameters, optimizing them to identify patterns and relationships in the training data. Training module 158 also addresses the challenge of overfitting by implementing techniques, like regularization and early stopping, ensuring the model's generalizability.

In an embodiment, evaluation and tuning module 160 evaluates the trained model's performance using the validation dataset (Operation 205). Evaluation and tuning module 160 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 152 receives a dataset intended for inference. Input/output module 152 assesses and validates the data (Operation 206).

In an embodiment, data preprocessing module 154 receives the validated dataset intended for inference (Operation 207). Data preprocessing module 154 ensures that the data format used in training is replicated for the new inference data, maintaining consistency and accuracy for the model's predictions.

In an embodiment, inference module 162 processes the new data set intended for inference, using the trained and tuned model (Operation 208). It applies the model to this data, generating raw probabilistic outputs for predictions. Inference module 162 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 164 allows for applications to leverage machine learning engine 130. In an embodiment, machine learning engine API 164 may be built on a RESTful architecture and offer stateless interactions over standard HTTP/HTTPS protocols. Machine learning engine API 164 may feature a variety of endpoints, each tailored to a specific function within machine learning engine 130. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 164 is equipped to support SOAP-based interactions. This extension involves defining a WSDL (Web Services Description Language) document that outlines the API's operations and the structure of request and response messages. In an embodiment, machine learning engine API 164 supports various data formats and communication styles. In an embodiment, machine learning engine API 164 endpoints may handle requests in JSON format or any other suitable format. For example, machine learning engine API 164 may process XML, and it may also be engineered to handle more compact and efficient data formats, such as Protocol Buffers or Avro, for use in bandwidth-limited scenarios.

In an embodiment, machine learning engine API 164 is designed to integrate WebSocket technology for applications necessitating real-time data processing and immediate feedback. This integration enables a continuous, bi-directional communication channel for a dynamic and interactive data exchange between the application and machine learning engine 130.

### 5. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a LLM. LLMs are designed to understand, generate, and interpret human language by processing extensive collections of data. The foundational architecture behind LLMs is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 152, when used for LLMs, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 154 in the context of LLMs may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 156, when used for LLMs involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 158, when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 160 assesses the performance of LLMs using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 162, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides LLMs and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond LLMs.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 6. Detecting Anomalous Network Activity and Generating Policies for Mitigating the Anomalous Activity

FIG. 3 illustrates an example set of operations for detecting anomalous network activity and generating policies for mitigating the anomalous activity in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments.

One or more embodiments access network details of a network, including scope, definitions, and policies (Operation 302). The network may include a cloud network, e.g., Oracle Cloud Infrastructure (OCI). The system may access network details by consulting documentation provided by the network provider, e.g., Oracle. Provider documentation may include network architecture, i.e., details on virtual network, subnets, and connectivity configurations. The system may use web-based management consoles and command-line interface tools to access the network details. The provider console may provide network security policies. The system may access network details using API's provided by a network provider. The system may periodically or continuously check for updates or changes to the network details.

One or more embodiments receive network flow logs from the network (Operation 304). The network flow logs capture information about IP traffic entering and exiting network interfaces in a virtual network. In cloud platforms, e.g., OCI, the system uses management consoles or API calls to access the network flow logs. Network providers may provide native solutions for generating flow logs. Routers and/or switches in the network may generate flow logs.

In one or more embodiments, the system filters the flow logs to isolate activity from components in the network with higher susceptibility to attacks. The system may target network flow logs from routers, switches and/or endpoints identified as having increased threat risk. The system may focus on network flow logs from components that have previously experienced anomalous activity or from similar types of components. The system may continuously monitor threats to the network and configure the filters accordingly.

One or more embodiments prompt a machine learning model to identify anomalous activity from the network and flow logs (Operation 306). The system may use a pre-trained model, e.g., Generative Pre-trained Transformer (GPT) or Bidirectional Encoder Representations from Transformers (BERT) model. The machine learning model may be fine-tuned with ZPL. The machine learning model may be fine-tuned using attack examples. A prompt generator may automatically generate prompts for applying to models. The prompts are provided in natural language and may include (i) a policy statement, (ii) rules for identifying anomalous activity, and (iii) remediation actions for addressing the anomalous activity. The prompt generator may provide the prompts directly to the machine learning model through a user interface, a command line, or an API call. The system may provide the prompts via API requests, e.g., using Python libraries, e.g., “requests” or “httpx”, to send a POST request to a model hosting server.

One or more embodiments apply the machine learning model to the network details and network flow logs to identify anomalous activity and generate security policies responsive to the anomalous activity (Operation 308). The system provides the network details and flow logs to the machine learning model through an interface designed for receiving input. The system may provide the information via scripting in languages, e.g., Python, using libraries to handle HTTP requests to APIs of the model. The system may continuously provide the network flow logs to the machine learning model. The system may continuously check for updates to the network details for providing to the machine learning model.

One or more embodiments detect anomalous activity in the network flow logs (Operation 308a). The machine learning model analyzes the network flow logs in real or near-real time. The machine learning model may detect patterns in the network flow logs that violate a security policy or that significantly deviate from established norms. During a session, the machine learning model can maintain context and remember previous interactions. This allows a comparison of network flow logs on a continuous basis.

One or more embodiments generate a new security policy responsive to the anomalous activity (Operation 308b). Once an anomaly is detected, the system may determine a potential impact of the anomaly. The system may classify the anomaly based on severity and type, e.g., Distributed Denial of Service (DDoS) attack, intrusion attempt, data exfiltration, etc. The system may generate a new security policy based on the prompts provided to the machine learning model. The new security policy may include (i) identification of the anomalous activity, (ii) proposed rules for mitigating the anomalous activity, and/or (iii) an explanation for the proposed rule. Identification of the anomalous activity may include providing the type of activity detected, e.g., unauthorized lateral movement. The proposed rules may include an action to be performed, e.g., isolate or deny. The proposed rule may include a source, destination, and/or protocol for the action. The proposed rule may include a reason for the action, e.g., suspicious lateral movement on sensitive ports, preventing further lateral movement. The explanation for the purposed rule may include a summary and observation of the activity. The system may save the new security policy as a JSON document in a file.

One or more embodiments upload the new security policy to a version control application (Operation 310). The system may load a new security policy file to a repository, e.g., Git repository, of the version control application, e.g., Git. The system may copy the new security policy to the repository directory using a file explorer or a command line. The system may use a staging command, e.g., git add, to stage the new security policy file for commit. Staging the new security policy for commit may include providing an explanation of what changes are being made and why the changes are being made. The system may push the security policy changes to a remote repository, e.g., GitHub. The version control application may use the command “git push” to transfer the changes to the remote repository. Pushing the new security policy updates the remote repository and may trigger automated processes, e.g., notification of administrators, automated checks. Pushing the security policy to the remote repository ensures subsequent changes are tracked. Tracking changes allows review or rolling back of the changes, when necessary.

One or more embodiments deploy the new security policies to the network (Operation 312). The system may set up a continuous integration/continuous deployment (CI/CD) pipeline that automates deployment of the new security policy from the version control application to the network. Tools, such as Jenkins, GitLab CI, or GitHub Actions, can trigger deployments based on pushed changes. The system may use tools, e.g., Terraform, to automate provisioning and management of resources according to the new security policy. These tools apply the configurations across the network consistently and repeatably.

One or more embodiments receive instruction to roll back the new security policy (Operation 314). A need to roll back a new security policy may arise if the newly deployed security policy is found to cause disruptions in normal operations, fails to meet security standards, or introduces new vulnerabilities. The system may determine a need to roll back a new security policy when the new security policy is determined to no longer be necessary or when the new security policy is determined to have been initiated in response to a false positive. The system may detect a need to roll back a new security policy through monitoring systems, incident reports, or during post-deployment testing. Administrators may provide the system with instruction to roll back a new security policy after determining that the policy is no longer necessary or was the result of a false positive.

In one or more embodiments, the system tracks interventions to generated policy. The system uses interventions to retrain the machine learning models.

One or more embodiments roll back the new security policy from the network (Operation 316). The version control application allows the rollback of the deployed security policy. Upon determining that a rollback of the security policy is required, the commit command that implemented the new security policy is identified. Identifying the commit command may include viewing a log of commits, e.g., Git log, to review the history and finding the commit, i.e., commit ID, that introduced the new security policy. The system may use a revert command, e.g., “git revert”, followed by a commit ID of the change that needs to be reverted to execute the reversion. The revert command may create a new commit that undoes the changes made by the original commit. By creating a new commit that reverses the effect of the previous commit, the history is not altered. The version control application may push the revert commit to the remote repository where the revert commit is deployed in a manner similar to the commit of the new security policy described above.

### 7. Example Prompts and Flow Logs for Detecting Anomalous Network Activity and New Security Policy for Mitigating the Anomalous Network Activity

A detailed example is described below for purposes of clarity. Components and/or operations described below should be understood as one specific example that may not be applicable to certain embodiments. Accordingly, components and/or operations described below should not be construed as limiting the scope of any of the claims.

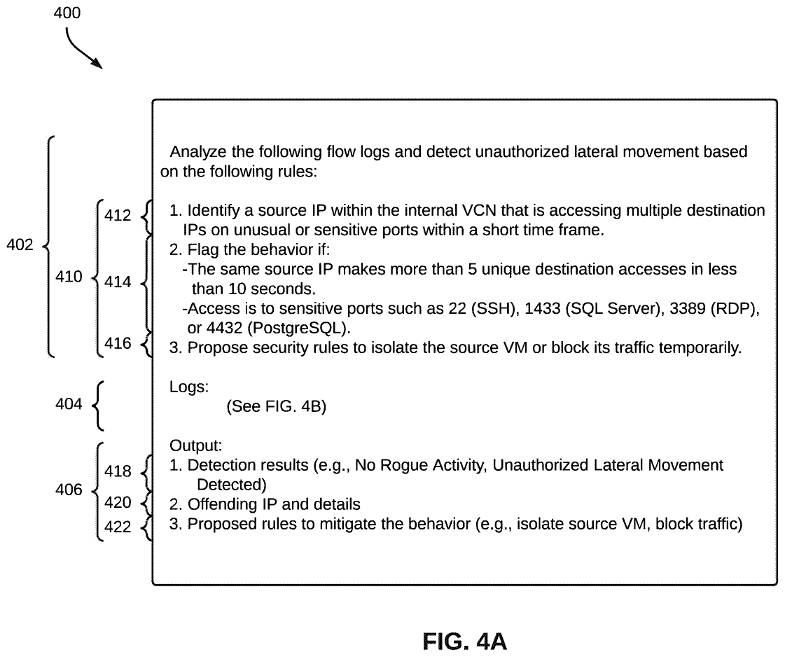

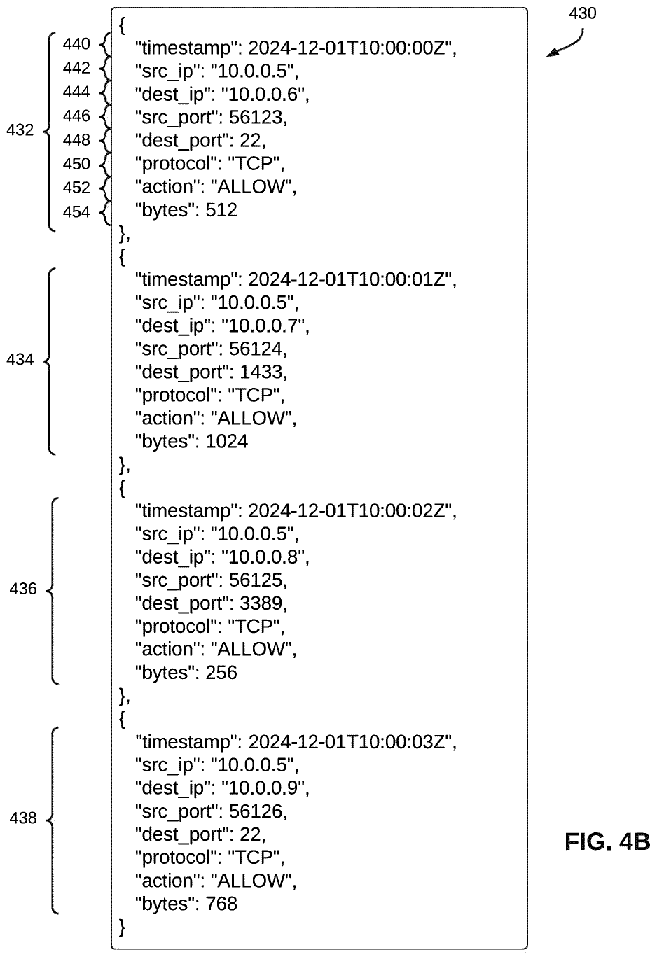

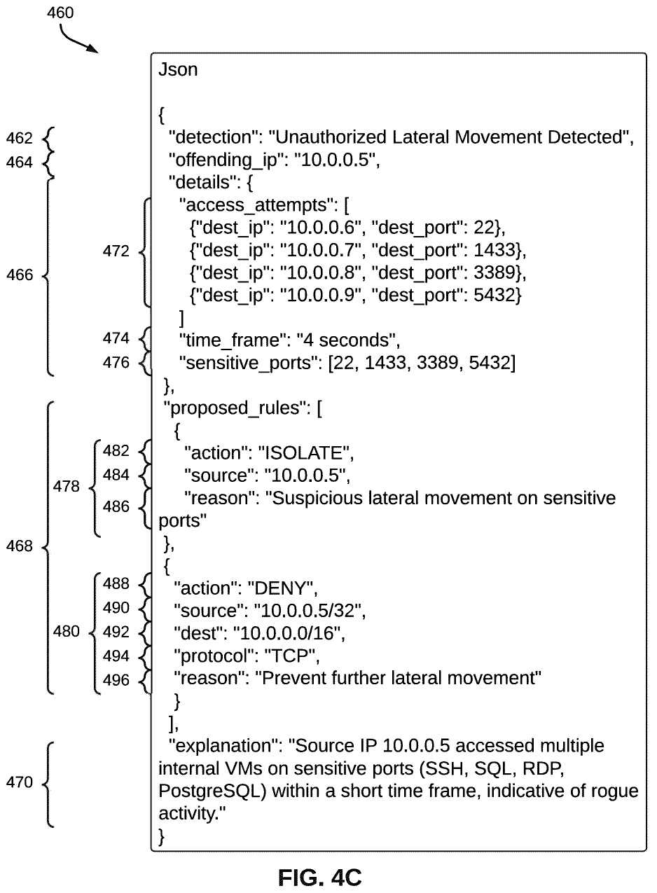

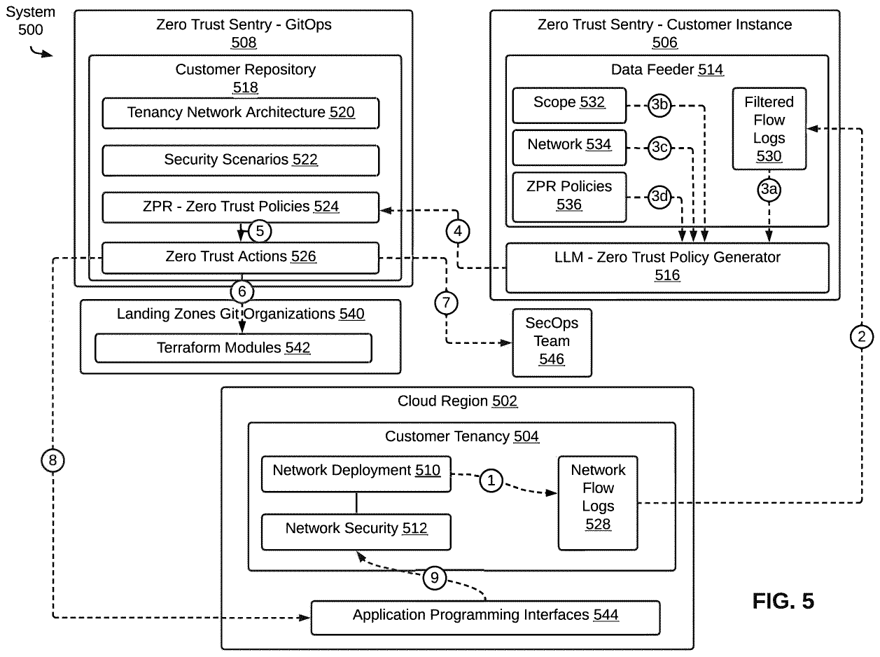

FIG. 4A illustrates an example policy prompt 400 in accordance with one or more embodiments. In this example, policy prompt 400 is provided to a generative AI model for detecting anomalous network activity and generating a new security policy responsive to the anomalous network activity. Policy prompt 400 includes analysis instructions 402, network flow logs 404, and output instructions 406.

As shown, analysis instructions 402 include a set of rules 410 for identifying anomalous behavior. Rules 410 indicate operations that a generative AI model is to perform to identify anomalous activity such as unauthorized lateral movement. Rules 410 include rules 412, 414, and 416. Rule 412 provides instructions for identifying source IP addresses associated with suspicious behavior. Rule 414 provides criteria for flagging the behavior identified in rule 412. Rule 416 instructs the model to propose security rules to mitigate the anomalous activity.

Network flow logs 404 are described with reference to FIG. 4B.

Output instructions 406 tell the model which outputs to produce. Specifically, instruction 418 tells the model to output detection results (e.g., if no rogue activity was detected or if unauthorized lateral movement was detected. Instruction 420 tells the model to output the offending IP address and details associated with the IP address. Instruction 422 tells the model to output proposed rules for mitigating the anomalous activity (e.g., to isolate the source virtual machine and/or block traffic).

FIG. 4B illustrates an example network flow log 430 in accordance with one or more embodiments. Specifically, in this example, network flow log 430 is to be provided as part of the policy prompt 400 of FIG. 4A. Network flow log 430 includes event logs 432, 434, 436, and 438. Categories of information provided in event logs 432, 434, 436, 438 are described here with reference to event log 432. Specifically, event log 432 identifies a timestamp 440, a source IP 442, a destination IP 444, a source port 446, a destination port 448, a protocol 450, an action 452, and bytes 454. Event log 432 captures a recorded instance of network activity. Timestamp 440 indicates when the event occurred. Source IP 442 identifies an originating device for the network activity. Destination IP 444 specifies a target endpoint for the network activity. Source port 446 represents an initiating port on a source machine for the network activity. Destination port 448 shows a service port being accessed. Protocol 450 describes the network protocol being used by the network activity. Action 452 logs whether the traffic was allowed or denied. Bytes 454 reflect an amount of data transferred.

FIG. 4C illustrates an example security policy 460 in accordance with one or more embodiments. Specifically, in this example, an AI model generates the security policy 460 responsive to detecting anomalous activity in network flow log 430 of FIG. 4B. Security policy 460 identifies a detection type 462, an offending IP 464, details 466 of the detection, proposed rules 468 for addressing the detection, and an explanation 470. Detection type 462 specifies a category of the threat or anomaly detected, e.g., port scan, brute-force login, or data exfiltration. Offending IP 464 identifies a source IP address responsible for the suspicious or malicious activity. Details 466 provide contextual information about the event, including, for example, affected ports, frequency, and duration of activity. Proposed rules 468 outline recommend security policy changes, e.g., blocking the offending IP or restricting access to sensitive services. Each rule defines what should be done, why, and the traffic the rule targets. Explanation 470 describes a rationale behind the proposed rules, linking the observed behavior to a specific threat or policy violation.

Details 466 of the detection include access attempts 472, a time frame 474, and sensitive ports 476. Access attempts 472 are the number and frequency of network connection attempts made by the offending source. Time frame 474 is the bounded time window during which the suspicious access attempts occurred. Sensitive ports 476 specific network ports targeted.

Proposed rules 468 include proposed rule 478 and proposed rule 480. Proposed rule 478 includes an action 482, a source 484, and a reason 486. Proposed rule 480 includes an action 488, a source 490, a destination 492, a protocol 494, and a reason 496. Action 482 is the enforcement operation to be taken, e.g., deny, isolate, alert, throttle. Source 484 is the origin of the traffic or behavior to act upon-often an IP address, VM ID, or subnet. Reason 486 is a justification for the rule based on observed behavior or detection analysis.

Explanation 470 provides an explanation of the activity determined to be anomalous. As shown, explanation 470 includes the source IP involved, the actions detected, and a conclusion resulting from the detected actions.

### 8. Example of Detecting and Mitigating Anomalous Activity

A detailed example is described below for purposes of clarity. Components and/or operations described below should be understood as one specific example that may not be applicable to certain embodiments. Accordingly, components and/or operations described below should not be construed as limiting the scope of any of the claims.

FIG. 5 illustrates an example of detecting and mitigating anomalous activity in accordance with one or more embodiments. In this example, a system 500 includes a cloud region 502 with a customer tenancy 504, a zero trust sentry customer instance 506, and a zero trust sentry GitOps 508. Cloud region 502 is a specific geographical data center zone in which cloud services operate, hosting all components of the system. Customer tenancy 504 is a logically isolated cloud environment assigned to a specific consumer, containing their deployed network resources and security configurations. Customer tenancy 504 includes a network deployment 510 and network security 512. Network deployment 510 is the customer's active cloud network infrastructure, including VCNs, subnets, gateways, and service endpoints. Network security 512 is the set of enforceable access control configurations, such as NSGs, security lists, and rout tables, that apply zero trust rules within the network. Zero trust sentry customer instance 506 is a cloud-deployed control component that monitors activity, detects threats, and collaborates with policy generators for the customer's specific environment. Zero trust sentry customer instance 506 includes a data feeder 514 and an LLM-. LLM-zero trust policy generator 516 is a large language model-based AI engine that analyzes telemetry and detection to generate declarative zero trust security policies. Zero trust sentry GitOps 508 is a GitOps automation layer responsible for storing, reviewing, and applying Zero Trust policies through infrastructure-as-code and version control mechanism. Zero Trust Sentry-GitOps 508 includes a customer repository 518 that includes tenancy network architecture 520, security scenarios 522, ZPR zero trust policies 524, and zero trust actions 526.

In an example set of operations, network deployment 510 of customer tenancy 504 in cloud region 502 generates network flow logs 528 (Operation 1). The system transmits network flow logs 528 (e.g., network flow log 430 of FIG. 4B), to data feeder 514 of zero trust sentry customer instance 506 (Operation 2). In this example, the system filters network flow logs 528 to generate filtered flow logs 530. Filtered flow logs 530 may include logs from high-risk machines and/or logs from critical system subnets. Data feeder 514 feeds filtered flow logs 530 along with additional data, i.e., scope 532, network 534, ZPR policies 536 to LLM-zero trust policy generator 516 (Operations 3a, 3b, 3c, 3d). LLM-zero trust policy generator 516 ingests the data from data feeder 514 and analyzes filtered flow logs 530 in accordance with policy prompts (e.g., policy prompt 400 of FIG. 4A). Responsive to detecting anomalous activity in the filtered flow logs 530, LLM-zero trust policy generator 516 generates a security policy (e.g., security policy 460 of FIG. 4C). The system encodes the new security policy into a ZPR format, e.g., JSON, Rego, YAML.

The system commits the new security policy to ZPR-zero trust policies 524 in customer repository 518 of zero trust sentry-GitOps 508 (Operation 4). ZPR-zero trust policies 524 are declarative policy definitions of security policies.

The system detects the change to ZPR-zero trust policies 524 (Operation 5). The system may detect the change via webhook or polling. The system validates the new security policy. Validating the new security policy includes automating enforcement and remediating the new security policy using git actions to generate zero trust actions 526.

The system may use terraform modules 542 of landing zones git organizations 540 to preview what Terraform will do based on the codified new security policy (Operation 6). Terraform modules 542 simulate the effect of enforcing the actions associated with the new security policy before actually applying the new security policy to the live infrastructure. The system may request approval from SecOps Team 546 to implement the new security policy (Operation 7). Alternatively, the system implements the new security policy automatically, i.e., without human approval.

The system uses APIs 544 to push the security policy to network deployment 510 (Operation 8). Based on the security policy, the system updates the network security 512 (Operation 9). The system continues to monitor the network flow logs 528 for anomalous activity. If the security policy includes a rollback provision, the system rolls back the new security policy after the trigger condition is met, i.e., specified time limit achieve or action performed. SecOps Team 546 may review the new security policy after the new security policy is implemented and determine that the new security policy was implemented in error. SecOps Team 546 may initiate rollback of the new security policy.

### 9. Practical Applications, Advantages & Improvements

One or more embodiments provide a technical solution to the technical problem of identifying anomalous activity in dynamic environments and mitigating the anomalous activity in real-time or near-real time. Real-time identification and mitigation of anomalous activity improves network security by reducing the amount of time that the anomalous activity is permitted to continue. By identifying the anomalous activity and implementing a new security policy responsive to the anomalous activity in real-time, the system reduces exposure of the network to the anomalous activity. Moreover, one or more embodiments use generative AI to continuously learn and adapt to new patterns, thereby improving threat detection. The generative AI dynamically analyzes network flow and topology. Generative AI may detect changes to the network topology and implement policies to address the changes in real time, thereby reducing the time that the system is exposed. In comparison, a human operator would not be capable of monitoring network traffic and implementing new policies in real-time. Identifying and mitigating network threats in real-time or near real-time is inherently a technical problem that cannot be solved without a technical solution.

One or more embodiments automatically roll back mitigative action once threats are resolved. Rolling back of mitigation action may also occur when a threat is identified as a false positive. The ability to automatically roll back mitigative actions reduces operational disruptions of the network.

### 10. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an API.

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 11. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

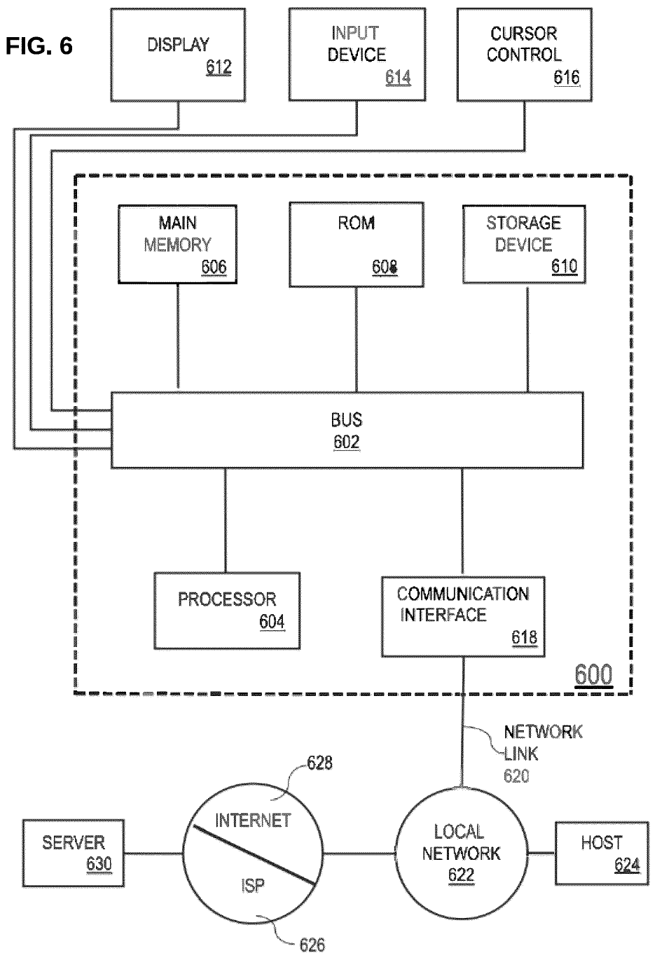

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 12. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
accessing, by a network security system executing in a computer network, network details comprising one or more of: a network scope; a network definition; or an existing security policy associated with the computer network;
accessing, by the network security system, network flow logs comprising metadata that describes network traffic associated with the computer network;
prompting, by the network security system, a machine learning model to (a) identify anomalous network activity based at least in part on the network details and the network flow logs and (b) generate new network security policies when anomalous network activity is detected;
receiving, by the network security system from the machine learning model, a new network security policy that addresses anomalous activity detected by the machine learning model; and
deploying, by the network security system, the new security policy to the computer network without human review or approval of the new security policy,
wherein the method is performed by at least one device including a hardware processor.

2. The method of claim 1, further comprising:
inspecting, by a zero trust policy packet routing (ZPR) network layer, a plurality of packets entering the computer network; and
storing the network flow logs, by the ZPR network layer, based at least in part on inspecting the plurality of packets.

3. The method of claim 1, further comprising:
receiving, by the network security system, an instruction to roll back the new security policy; and
responsive to receiving the instruction to roll back the new security policy: performing, by the network security system, one or more of:
(a) taking the new security policy offline; or
(b) replacing the new security policy with an earlier security policy.

4. The method of claim 3, further comprising:
uploading, by the network security system, the new security policy into a version control application;
wherein replacing the new security policy with the earlier security policy comprises:
accessing the earlier security policy from the version control application; and
deploying the earlier security policy to the computer network.

5. The method of claim 1, further comprising:
determining that network traffic associated with a first subset of the network flow logs has a higher susceptibility to attacks than network traffic associated with a second subset of the network flow logs; and
filtering the network flow logs to include the first subset of the network flow logs without including the second subset of the network flow logs.

6. The method of claim 1, wherein the network flow logs comprise one or more of: timestamps; source Internet Protocol (IP) addresses; or cloud service region identifiers associated with network traffic.

7. The method of claim 1, wherein the new security policy comprises:
(a) a human readable rule that defines anomalous activity; and
(b) a definition of an action to perform responsive to detecting the anomalous activity.

8. The method of claim 1, wherein the machine learning model is a generative artificial intelligence (GenAI) model.

9. The method of claim 1, wherein the machine learning model is a large language model (LLM) and wherein prompting the machine learning model to identify anomalous network activity and generate new network security policies comprises:
generating a natural language prompt; and
submitting the natural language prompt to the LLM.

10. One or more non-transitory computer readable media comprising instructions which, when executed by one or more hardware processors, cause performance of operations comprising:
accessing, by a network security system executing in a computer network, network details comprising one or more of: a network scope; a network definition; or an existing security policy associated with the computer network;
accessing, by the network security system, network flow logs comprising metadata that describes network traffic associated with the computer network;
prompting, by the network security system, a machine learning model to (a) identify anomalous network activity based at least in part on the network details and the network flow logs and (b) generate new network security policies when anomalous network activity is detected;
receiving, by the network security system from the machine learning model, a new network security policy that addresses anomalous activity detected by the machine learning model;
deploying, by the network security system, the new security policy to the computer network without human review or approval of the new security policy.

11. The non-transitory computer readable media of claim 10, wherein the operations further comprise:
inspecting, by a zero trust policy packet routing (ZPR) framework, a plurality of packets entering the computer network;
storing the network flow logs, by the ZPR framework, based at least in part on inspecting the plurality of packets.

12. The non-transitory computer readable media of claim 10, wherein the operations further comprise:
receiving, by the network security system, an instruction to roll back the new security policy;
responsive to receiving the instruction to roll back the new security policy: performing, by the network security system, one or more of:
(a) taking the new security policy offline; or
(b) replacing the new security policy with an earlier security policy.

13. The non-transitory computer readable media of claim 12, wherein the operations further comprise:
uploading, by the network security system, the new security policy into a version control application;
wherein replacing the new security policy with the earlier security policy comprises:
accessing the earlier security policy from the version control application; and
deploying the earlier security policy to the computer network.

14. The non-transitory computer readable media of claim 10, wherein the operations further comprise:
determining that network traffic associated with a first subset of the network flow logs has a higher susceptibility to attacks than network traffic associated with a second subset of the network flow logs; and
filtering the network flow logs to include the first subset of the network flow logs without including the second subset of the network flow logs.

15. The non-transitory computer readable media of claim 10, wherein the network flow logs comprise one or more of: timestamps; source Internet Protocol (IP) addresses; or cloud service region identifiers associated with network traffic.

16. The non-transitory computer readable media of claim 10, wherein the new security policy comprises:
(a) a human readable rule that defines anomalous activity; and
(b) a definition of an action to perform responsive to detecting the anomalous activity.

17. The non-transitory computer readable media of claim 10, wherein the machine learning model is a generative artificial intelligence (GenAI) model.

18. The non-transitory computer readable media of claim 10, wherein the machine learning model is a large language model (LLM), and wherein prompting the machine learning model to identify anomalous network activity and generate new network security policies comprises:
generating a natural language prompt; and
submitting the natural language prompt to the LLM.

19. A system comprising:
at least one device including a hardware processor;
the system being configured to perform operations comprising:
accessing, by a network security system executing in a computer network, network details comprising one or more of: a network scope; a network definition; or an existing security policy associated with the computer network;
accessing, by the network security system, network flow logs comprising metadata that describes network traffic associated with the computer network;
prompting, by the network security system, a machine learning model to (a) identify anomalous network activity based at least in part on the network details and the network flow logs and (b) generate new network security policies when anomalous network activity is detected;
receiving, by the network security system from the machine learning model, a new network security policy that addresses anomalous activity detected by the machine learning model; and
deploying, by the network security system, the new security policy to the computer network without human review or approval of the new security policy.

20. The system of claim 19, wherein the operations further comprise:
inspecting, by a zero trust policy packet routing (ZPR) network layer, a plurality of packets entering the computer network; and
storing the network flow logs, by the ZPR network layer, based at least in part on inspecting the plurality of packets.
